(19) United States
(12) Patent Application Publication
(10) Pub. No.: US 2026/0246667 A1
(43) Pub. Date: Aug. 20, 2026

(54) METHOD OF NON-LINE-OF-SIGHT (NLOS) CHANNEL ESTIMATION IN A 3D VOXELATED GRID-MAP REPRESENTING A WIRELESS COMMUNICATION ENVIRONMENT

(71) Applicant: Continental Automotive Technologies GmbH, Hannover (DE)

(72) Inventors: David Gonzalez Gonzalez, Egelsbach, Hessen (DE); Osvaldo Gonsa, Frankfurt (DE); Hyeon Seok Rou, Bremen (DE); Giuseppe Thadeu Freitas de Abreu, Bremen (DE)

(73) Assignee: Continental Automotive Technologies GmbH, Hannover (DE)

(21) Appl. No.: 19/164,186

(22) PCT Filed: Mar. 12, 2024
(86) PCT No.: PCT/EP2024/056541

§ 371 Date: Sep. 10, 2025

(30) Foreign Application Priority Data
Mar. 14, 2023 (DE) 10 2023 202 288.5

(51) Int. Cl. H04L 25/02

(52) U.S. Cl. CPC H04L 25/0242; H04L 25/0212; H04L 25/0224

(57) ABSTRACT

A method of estimating NLOS sub-paths of a channel in a 3D voxelated grid map representing a wireless communication environment comprises receiving a transmitted signal comprising at least one pilot symbol. Based on the at least one pilot symbol an estimation of the time-domain channel coefficient matrix for the total effective channel is obtained. Further, an estimation of the channel coefficient matrix for LOS sub-paths of the channel is obtained. From these the aggregate NLOS channel coefficient matrix is obtained, and decomposed into a product of respective channel coefficient matrices for the NLOS UE-to-voxel paths and the NLOS voxel-to-AP paths, as well as the matrix representing the diagonalised voxelated environment. The individual decomposed constituents are determined through iterative estimation operations. In each iteration, sequentially each one of the matrices is estimated while the other two matrices are fixed. The iteration is terminated when a termination criterion is met.

### CROSS REFERENCE TO RELATED APPLICATIONS

This application is the U.S. National Phase Application of PCT International Application No. PCT/EP2024/056541, filed Mar. 12, 2024, which claims priority to German Patent Application No. 10 2023 202 288.5, filed Mar. 14, 2023, the contents of such applications being incorporated by reference herein.

### FIELD OF THE INVENTION

The present invention relates to wireless communication systems, more specifically to estimating NLOS channels in wireless communication systems, in particular those performing joint communication and sensing (JCAS). More specifically, the invention relates to a method of estimating NLOS channels, to a computer program product implementing the method, to a computer-readable storage medium storing the computer program product, to a receiver configured to execute the method, and to a system including such receiver. Throughout this specification the term environment sensing may be used for the various expressions widely used for capturing information about an environment for creating a three-dimensional representation thereof.

### NOTATIONS

Scalar values are denoted herein by lowercase letters in italics, as in x, while complex vectors and matrices are denoted by boldface lowercase and uppercase letters, as in x and X, respectively. [symbol] denotes the complex number field.

### BACKGROUND

JCAS is a technique in wireless communications with the objective of retrieving information about the environment from the signal scattering which is present in the effective channel state information (CSI), e.g., due to objects in the environment, blockage, user activity, etc., while simultaneously achieving data communication. Most known JCAS methods exploit radar technology to infer information about the environment. This is also known as joint radar and communication (JRC).

Various methods are known in JRC, including alternating or sharing spectrum between radar and communication signals, using standard radar signals to embed information, extracting radar parameters from standard communication signals, or even designing new waveforms suited for both tasks. These techniques are highly based on conventional radar signal processing (e.g., ambiguity function estimation) and dependent on the radar frequency-delay properties and prone to similar challenges.

In robotics vision and mapping 3D voxelated occupancy grids were introduced for systemizing the collection of environment information. An exemplary environment is shown in FIG. 1 a). The total region of interest (ROI) is defined as a cuboidal space of dimensions Lₓ×L_{y}×L_{z}, each denoting the lengths of the x, y, z-axes in meters, respectively.

The entire ROI is subdivided into a grid consisting of Nᵥ≙Nₓ·N_{y}·N_{z} voxels, where

$${N}_{x} \hat{=} \frac{{L}_{x}}{{L}_{V}} , {N}_{y} \hat{=} \frac{{L}_{y}}{{L}_{V}} , and {N}_{z} \hat{=} \frac{{L}_{z}}{{L}_{V}}$$

denoted the number of voxels per x, y, z-axes respectively, and L_{y} is the edge length of a voxel cube in meters. If represented as a tensor of three dimensions (Nₓ×N_{y}×N_{z}), the voxelated occupancy grid directly represents a discretized model of the ROI as shown in FIGS. 1 b) and c), where the size of the voxels corresponds to the image resolution.

The voxelated environment first introduced in robotics vision and mapping may be exploited for devising methods of joint communication and environment detection, which operate without the usage of radar properties, i.e., mainly relying on pure communication signals.

For example, in “Joint Multi-User Communication and Sensing Exploiting Both Signal and Environment Sparsity,” IEEE Journal of Selected Topics in Signal Processing, vol. 15, no. 6, pp. 1409-1422 November 2021, X. Tong, Z. Zhang, J. Wang, C. Huang and M. Debbah, incorporated herein by reference, consider a regular voxelated 3D space with some scatterer objects accommodating a single access point (AP), a single reconfigurable intelligent surface (RIS), and multiple single-antenna user equipment (UEs). The multiple UEs are communicating to the AP via sparse code multiple access (SCMA) over multiple frequency subcarriers and over multiple transmission instances, via line-of-sight (LOS) paths and non-line-of-sight (NLOS) paths from the UEs, to the scatters, to the RIS, then finally to the AP.

A general concept of LOS and NLOS paths in a voxelated space is shown in FIG. 2. The LOS path is the direct path between the UE and the AP, while the two occupied voxels in the ROI reflect signals emitted by the UE towards the AP. The dashed lines represent the NLOS UE-to-voxel path, and the dotted lines represent the NLOS voxel-to-AP path.

FIG. 3 shows a schematic representation of the 3D space considered in the aforementioned known system and method, including the RIS. Here, the signal reflected off the RIS towards the single AP is shown in a dash-dotted line, to highlight its specific origin. The requirement of a RIS in the system limits the general application of the known methods to specific environments, rendering the application thereof in in real-world environments difficult and unsatisfactory.

With increasing system size, i.e., increasing number of UEs, APs, and voxels, as exemplarily shown in FIG. 4, it can be seen that the numbers of the sub-paths will increase substantially-further noticing that the illustration in FIG. 4 only depicts a simplified system for single antenna UEs and single antenna APs. It is obvious that in a more realistic multiple-input-multiple-output (MIMO) setting with multi-antenna UEs and multi-antenna APs, the number of sub-paths will further increase manyfold.

While the sensing part alone may pose a difficult problem to solve on its own, properly addressing the communication part represents no smaller problem. Modern communication requires estimating the channel properties in a receiver as best as possible for recovering the transmitted symbols in an efficient and reliable way. Determining channel properties in pure LOS environments is a well-known practice. However, doing so in environments having multiple objects that reflect transmitted signals such that, inter alia, multiple representations of the transmitted signal arrive at respective different times at the receiver due to the longer paths of the reflected copy vs. the LOS signal, requires taking a different approach. Simply assuming that the channel properties of all NLOS signal path segments are the same as those of the LOS signal paths, and merely compensating for the time delay does not provide satisfying results.

### SUMMARY OF THE INVENTION

There is, thus, a need for a method for improved estimation of NLOS path channels, in particular in communication settings with multiple UEs and multiple APs that use a voxelated grid model of their environment, and further for a receiver configured for executing the method.

An aspect of the present invention recognises that the NLOS path channels can be represented by path sections UE-to-voxel and voxel-to-AP, as shown in FIG. 4. Further, an aspect of the invention considers that the reflecting objects themselves may have a significant influence on the channel properties or coefficients. Consider each voxel to be represented by a voxel occupancy coefficient vₖ∈{0, 1} with k ∈{1, . . . , N_{V}}, where vₖ=0 indicates that the k-th voxel is empty, i.e., the corresponding environment is free-space, and vₖ=1 indicates that the k-th voxel is occupied by a scatterer object, e.g., the table, chair or the object on the wall, as illustrated in FIG. 1 a). An aspect of the invention yet further recognises that, in an assumed uplink scenario, the voxel-to-AP path segment will most likely have channel matrix coefficients that differ significantly from those of the UE-to-voxel path segment. Thus, the binary voxel occupancy coefficients may be extended to complex voxel scattering coefficients, i.e., vₖ ≙βₖ·e^{jω}^{ₖ} ∈ [symbol] , to also capture the effect incurred to the reflected electromagnetic waves by the occupied voxels. The values of the voxel scattering coefficients, including signal attenuation, are expected to be highly dependent on the electromagnetic characteristics of the scatterer object and of the impinging electromagnetic wave. The influence of the voxel scattering coefficients, notably on the path segment from the scattering object to the receiver, on the NLOS paths complicates the full NLOS channel estimation.

An aspect of the invention further recognises that the sensing part of JCAS provides additional information that may be used in the NLOS channel estimation, since the sensing part of JCAS provides a representation of the environment in the form of a voxelated grid-map.

Thus, the method described hereinafter is based on a system model in which the received signal matrix Y is obtained by

$$Y = ( H + A V B ) [ {X}_{p} ] + W = ( H + \overline{H} ) [ {X}_{p} ] + W = G [ {X}_{p} ] + W ,$$

where H, A, B are the sub-path channel coefficient matrices corresponding to the LOS path, NLOS UE-to-voxel path, NLOS voxel-to-AP path, respectively, V is the diagonalised voxelated environment represented by the voxel scattering coefficients, Xₚ is the pilot signal matrix, G is the effective total channel, and W is 15 the additive white Gaussian noise (AWGN) matrix. The aggregate, i.e., composite, NLOS channel is given by H̅=AVB, and finally the total effective channel matrix is given by G=H+H̅=H+AVB.

With the pilot signals being known, it is possible to first estimate the effective total channel G. Once the effective total channel G is determined, the LOS channel H can be determined, and it is possible to finally extract the estimate of the aggregate NLOS channel H̅. Determination of the LOS channel H may include using only those copies of the received signal that arrives first at the receiver, or using a priori knowledge of the locations of the APs and UEs in the voxelated environment, or the like.

Obviously, knowing only the estimate of the aggregate NLOS channel H̅ is not the same as knowing the channel coefficient matrices A and B, and the respective properties of the voxels.

While the general representation of the aggregate NLOS channel H̅ as the product of the channel coefficient matrices A and B and the diagonalised voxelated environment V may suggest the application of known matrix diagonalization methods, e.g., singular value decomposition, or eigenvalue decomposition, a closer examination of the statistics of the constituent matrices reveals that this is a diagonalization problem whose solution is not so straight forward. First, the K×K diagonal matrix V is a sparse diagonal matrix, which means that only ƒ values are non-zero (where ζ<K). Second, there are also constraints on the power balance between A and B, i.e., the two must have the same mean power, since they are both actual channel coefficients and not just arbitrary decomposed matrices. These constraints prevent the application of the well-known diagonalization methods and require a novel approach for tackling this problem.

Thus, in accordance with a first aspect of the present invention, a method of estimating NLOS sub-paths of a channel in a 3D voxelated grid map representing a wireless communication environment comprises receiving, at a receiver having one or more antennas, a transmitted signal comprising at least one pilot symbol. The transmitted signal may further comprise one or more data symbols. The at least one pilot symbol will typically be transmitted in a pilot symbol matrix of a transmission frame, and the at least one data symbol will typically be transmitted in a data symbol matrix of the transmission frame, although other arrangements may be possible. The one or more pilot symbols are known beforehand at the receiver. The at least one pilot symbol is provided to a channel estimation unit for obtaining an estimation of the time-domain channel matrix G representing the total effective channel, which channel matrix G is provided at an output of the channel estimation unit. The channel estimation unit may perform any suitable kind of channel estimation, including iterative channel estimations using data symbols, if available, obtained as pseudo pilot symbols, e.g., as presented in the German patent applications no. 10 2022 125 445.2 and 10 2022 127 946.4, the entire content of which is hereby incorporated by reference. Based on the channel coefficient matrix G an estimation of the channel coefficient matrix HI for all LOS sub paths of the channel is determined.

As mentioned above, the LOS sub paths may be determined by any one of generally known methods, for example, by considering only those signals that arrive first, ignoring delayed copies thereof. Other methods may use prior knowledge of the relative positions of the UEs and the AP as required by electronic beamforming for identifying the LOS paths, or communicating on a channel having a lower frequency, where NLOS scattering becomes negligible. Once the geometric LOS path is determined, the channel coefficients can be determined using generally known channel estimation methods.

From the channel coefficient matrix G representing the total effective channel and the channel coefficient matrix H representing LOS sub-paths of the channel the aggregate NLOS channel coefficient matrix H̅ is extracted. The aggregate NLOS channel coefficient matrix H̅ is then decomposed into the respective channel coefficient matrices for the NLOS UE-to-voxel paths A and the NLOS voxel-to-AP paths B, as well as the matrix V representing the diagonalised voxelated environment. The decomposition uses the knowledge that V is a diagonal matrix, whose diagonal elements are from a known set, and an estimate of the mean of the diagonal values of V is assumed to be known. The known set may comprise binary values 0 and 1, or real numbers between 0 and 1. FIG. 5 shows an exemplary illustration of the composition of the matrix H̅ as the product of the matrices AVB. In the matrix V representing the diagonalised voxelated environment the places in the diagonal are set to binary values, represented by black or white filling, in accordance with the respective estimates.

Finally, in accordance with an aspect of the invention the channel coefficient matrices for the NLOS UE-to-voxel paths A and the NLOS voxel-to-AP paths B, as well as the matrix V representing the diagonalised voxelated environment, are determined through iterative estimation operations. In each iteration sequentially each one of the matrices is estimated while the other two matrices are fixed. The iteration is terminated when a termination criterion is met.

In one or more embodiments of the method determining the channel coefficient matrices for the NLOS UE-to-voxel paths A and the NLOS voxel-to-AP paths B, as well as the matrix V representing the diagonalised voxelated environment through iterative estimation operations comprises transforming the system model describing the composite NLOS channel, H̅=AVB, i.e., a product of matrices as described further above, into a tensor product H̅=AVB with constrained tensors, distinguished by the slanted bold uppercase letters as opposed to the upright bold uppercase letter. More precisely, a tensor H̅ is represented through the product of tensors for the NLOS UE-to-voxel paths A and the NLOS voxel-to-AP paths B, respectively, as well for the diagonalised voxelated environment V. An exemplary illustration of the tensors is shown in FIG. 6. Thus, the original channel matrix decomposition problem, where each of the decoupled components are matrices, is transformed into a tensor decomposition problem, which may be solved by applying generally known tensor decomposition methods for obtaining the respective constituent tensors. In a preferred embodiment the tensor decomposition is a multi-linear generalised singular value decomposition (ML-GSVD).

The transformation of the composite NLOS channel, H̅=AVB into a tensor product H̅=AVB preferably comprises casting the N×M matrix H̅ to a tensor H̅ of size 1×N×M, casting the N×K matrix A to a tensor A of size 1×K×N, duplicating the K×K matrix V to a tensor V of size K×K×N, and casting the K×M matrix B to a tensor B of size K×M×1. Note that each of the tensors V represents a ‘page’ that is a plain copy of the matrix V, and that B is a ‘common matrix’, i.e., the same B is used for all pages. The various tensors are shown in FIG. 6, where in particular the vector-like tensor H̅ and A and the identical copied “pages” of the tensor V stick out.

As previously mentioned, the resulting constrained tensor system can then be solved using known tensor decomposition methods. One exemplary known tensor decomposition method employs a PARAFAC framework, e.g., as presented by Mark H. Van Benthem, Timothy J. Keller, Gregory D. Gillispie, Stephanie A. DeJong, in “Getting to the core of PARAFAC2, a nonnegative approach”, Chemometrics and Intelligent Laboratory Systems, 2020, incorporated herein by reference, to perform an SVD-like algorithm (singular value decomposition). An exemplary SVD algorithm method is described by L. Khamidullina, A. L. F. de Almeida and M. Haardt, in “Multilinear Generalized Singular Value Decomposition (ML-GVSD) with Application to Coordinated Beamforming in Multi-user MIMO Systems,” ICASSP, 2020, incorporated herein by reference. Unlike a typical tensor decomposition framework based on Tucker products, the method in accordance with an aspect of the invention represents tensors as a product of concatenated ‘slices’ or ‘pages’, as shown in FIG. 6.

Based on this, the method proceeds to iteratively and alternatingly estimating the tensors. While the conventional methods possess a problem in that the sparsity, discreteness, and power constraints cannot be enforced, using an iterative procedure allows for embedding some statistical constraints at each step of the estimation.

The alternating iterative estimation may essentially follow the same steps as described in the German patent application no. 10 2022 212 615.7 filed by the same applicant, the entire content of which is hereby incorporated by reference. For example, following the ML-GVSD method, the following steps may iteratively be repeated until a termination criterion is met:

a) Update the tensor A for the NLOS UE-to-voxel paths using the previously fixed common tensors B for the NLOS voxel-to-AP paths and V for the diagonalised voxelated environment, considering the channel statistics of the NLOS UE-to-voxel paths A.

b) Update the tensor V for the diagonalised voxelated environment using previously fixed common tensor B for the NLOS voxel-to-AP paths and the updated tensor for the NLOS UE-to-voxel paths A, considering the sparsity of the diagonalised voxelated environment V.

c) Update the common tensor B for the NLOS voxel-to-AP paths using the previously fixed updated tensors for the NLOS UE-to-voxel paths A and for the diagonalised voxelated environment V, considering the channel statistics of the NLOS voxel-to-AP paths B.

It goes without saying that each subsequent iteration uses the respective latest updated tensors.

The termination criterion can include, for example, a predetermined numerical iteration limit, or a convergence of the estimate within a predetermined range or below a predetermined value. Such convergence criterion can be fulfilled, e.g., when the average change between consecutive post-iteration estimates is below the predetermined value.

Prior to the alternating iterative estimation, the common tensor B may be initialised, e.g., based on channel statistics, and the diagonal tensors V may be initialised based on the environment sparsity. It is reminded that all pages of V are identical. The channel statistics can, for example, be estimated from the statistics of the effective total channel G and the environment sparsity estimate. It is also possible to use random values from a range of possible values for the initialisation.

The method presented hereinbefore may be represented by computer program instructions of a computer program product. Accordingly, in accordance with a second aspect of the invention, a computer program product comprises computer program instructions, which, when executed by a processor of or functionally coupled with a receiver, cause the processor and/or the receiver to carry out a method in accordance with one or more of the various embodiments of the first aspect.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

In accordance with a third aspect of the present invention a receiver for wireless communication signals comprises at least one antenna, circuitry for processing radio frequency signals, a microprocessor, volatile and non-volatile memory, which elements or components are connected via one or more data and/or signal lines or buses. The non-volatile memory stores computer program instructions which, when executed by the microprocessor, configure elements or components of the receiver to implement or carry out one or more embodiments of the method in accordance with the first aspect of the present invention.

In one or more embodiments the receiver is co-located to a transmitter configured for sending communication signals.

In one or more embodiments the circuitry for processing radio frequency signals comprises a low noise amplifier and/or a mixer configured for providing a representation of a received signal at an intermediate frequency. The mixer preferably uses a same oscillator signal as a transmitter co-located with the receiver. The latter may enable using signals transmitted by the entity comprising the receiver, which are reflected off objects, for environment perception.

The receiver according to the third aspect of the invention and a corresponding transmitter configured for transmitting communication signals having at least one pilot signal may form a system permitting estimation of NLOS channels in accordance with embodiments of the method presented hereinbefore.

An aspect of the present invention provides a novel method of estimating the NLOS channel in a voxelated grip-map, inter alia, by decomposing the channel matrix of the NLOS channel paths into separate matrices representing the UE-to-voxel path segments, the voxel-to-AP path segments and the properties of the voxels in the voxelated space. A specific embodiment using tensor-based decomposition provides a practical and efficient solution for imposing the otherwise difficult-to-handle constraint on the matrix representing the properties of the voxels in the voxelated space due to its sparsity and mean constraints. The tensor-based decomposition also permits an efficient imposing of the power constraints on the channel matrices representing the UE-to-voxel path segments and the voxel-to-AP path segments. The method advantageously permits for simultaneous estimation of all sub-components from a single observation matrix.

An aspect of the present invention can advantageously be used in several communication scenarios, inter alia by UEs in an indoor scenario with stationary APs, communicating and detecting an environment, by mobile vehicles communicating to roadside units (RSUs) while achieving vehicular/pedestrian detection, by multiple vehicles cooperatively sensing an environment and road conditions without RSUs, by multiple connected UEs (Bluetooth, Wi-Fi, IoT, etc.)

for passively sensing an environment (i.e., without the use of sensing specific signals), and the like.

### BRIEF DESCRIPTION OF THE DRAWING

In the following section embodiments of the invention will be described with reference to the drawing, in which

FIGS. 1 a)-1 c) show an exemplary environment and its representation as 3D voxelated occupancy grid in different resolutions,

FIG. 2 shows a general concept of LOS and NLOS paths in a voxelated space, FIG. 3 shows a schematic representation of the 3D space including an RIS considered in a prior art system and method,

FIG. 4 shows a more complex communication system having multiple APs and UEs, and the increased number of LOS and NLOS paths,

FIG. 5 shows an exemplary illustration of the composition of the aggregate NLOS channel coefficient matrix H̅ as the product of the matrices A, V, and B,

FIG. 6 shows exemplary illustration of the composition of the aggregate NLOS channel coefficient matrix H̅ as tensor product H̅=AVB,

FIG. 7 shows an exemplary flow diagram of an embodiment of the method in accordance with the invention,

FIG. 8 shows a first exemplary block diagram of a receiver adapted to execute embodiments of the method in accordance with the invention, and

FIG. 9 shows an exemplary and schematic diagram of a communication system in accordance with an aspect of the invention.

In the figures, identical or similar elements may be referenced using the same reference designators.

### DETAILED DESCRIPTION OF EMBODIMENTS

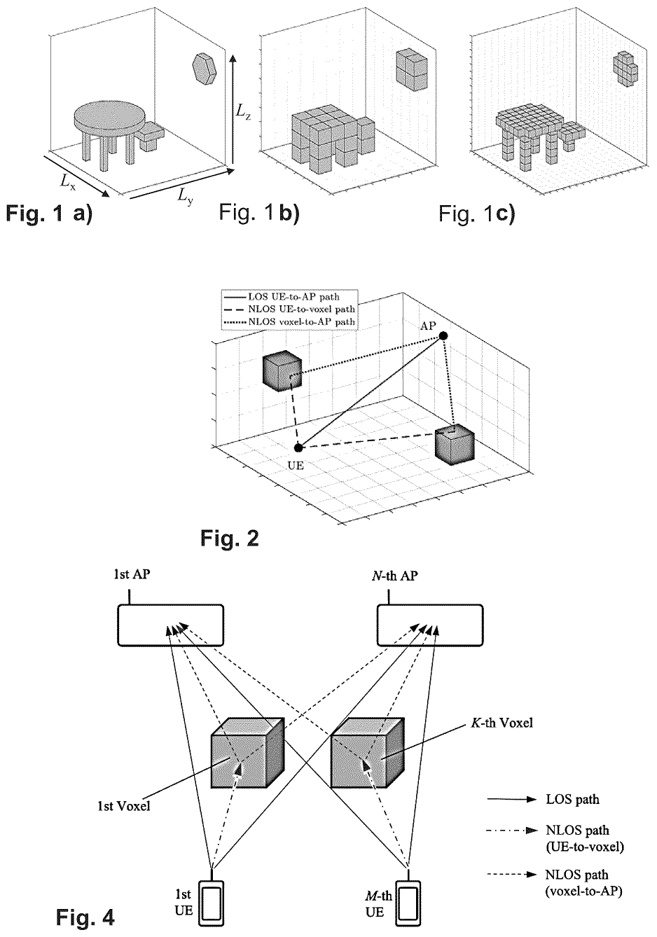

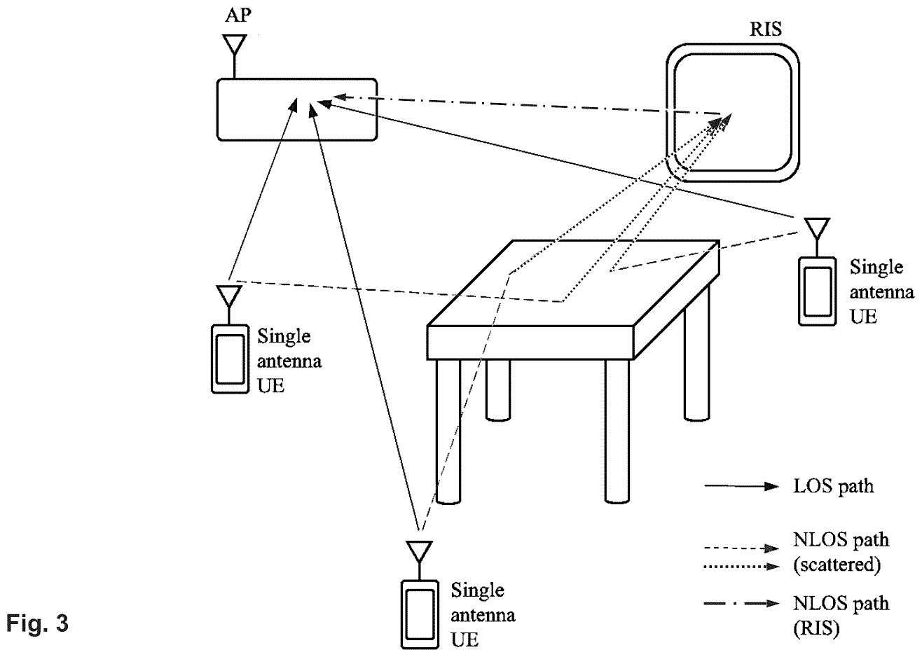

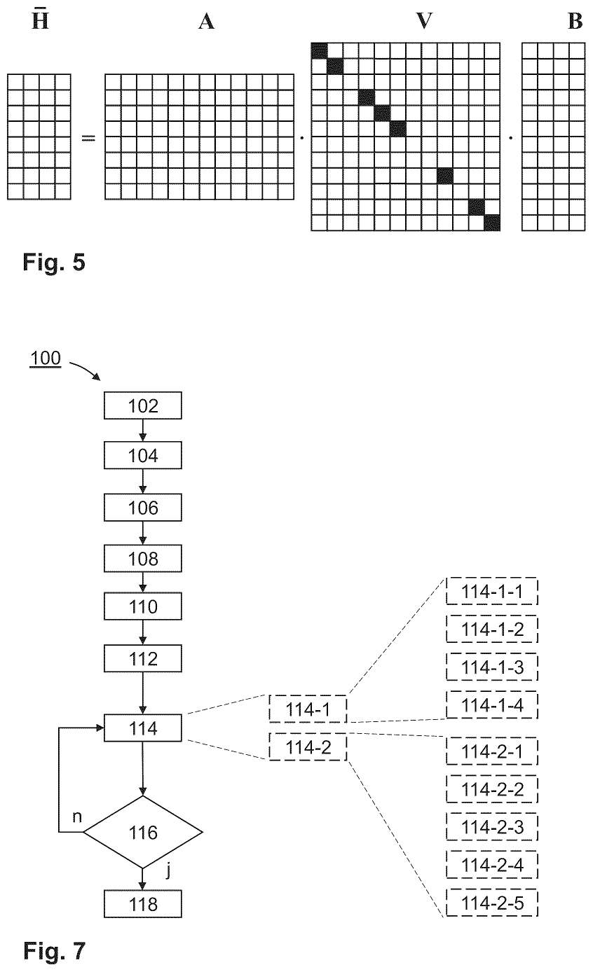

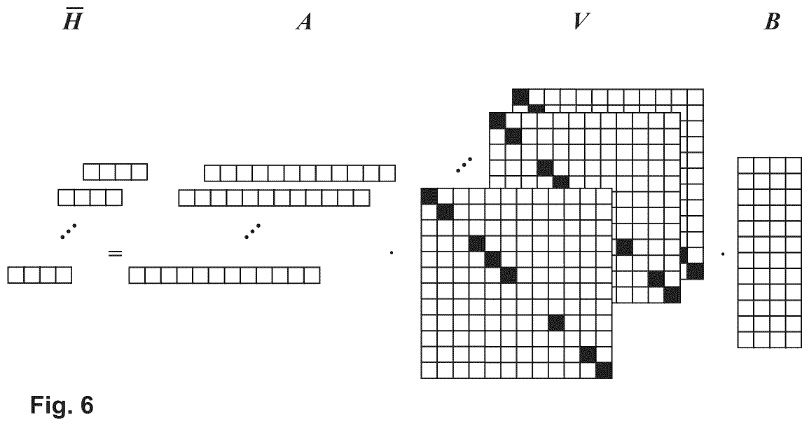

FIGS. 1 a) to 6 have been described further above and will not be discussed again.

FIG. 7 shows an exemplary flow diagram of an embodiment of the method 100 in accordance with the invention. In step 102 a transmitted signal X comprising at least one pilot symbol Xₚ is received, and in step 104 the at least one pilot symbol is provided to a channel estimation unit 208, for obtaining 106, at an output of the channel estimation unit 208, an estimation of the time-domain channel coefficient matrix G representing the total effective channel. In step 106 an estimation of the time-domain channel coefficient matrix G representing the total effective channel is obtained at an output of the channel estimation unit 208. Next, in step 108, an estimation of the channel coefficient matrix H for LOS sub-paths of the channel is determined. In step 110 the aggregate NLOS channel coefficient matrix H̅ is extracted from the channel coefficient matrix G representing the total effective channel and the channel coefficient matrix H representing LOS sub-paths of the channel. In step 112 the aggregate NLOS channel coefficient matrix H̅ is decomposed into a product of respective channel coefficient matrices for the NLOS UE-to-voxel paths A and the NLOS voxel-to-AP paths B, as well as the matrix V representing the diagonalised voxelated environment. Finally, in step 114, the channel coefficient matrices for the NLOS UE-to-voxel paths A and the NLOS voxel-to-AP paths B, as well as the matrix V representing the diagonalised voxelated environment are determined, through iterative estimation operations. In each iteration, sequentially each one of the matrices is estimated while the other two matrices are fixed. In step 116 a check is performed to find out if a termination criterion is met. In the negative case, “no”-branch of step 116, the next iteration is executed. Otherwise, “yes”-branch of step 116, the determination is terminated and the results may be output in step 118, for use in a subsequent signal detection (not shown in the figure.

As shown in the figure, step 114 may comprise a step 114-1, in which the matrices H̅, A, B, and V are transformed into tensors H̅, A, B, and V, and a step 114-2, in which a tensor decomposition is executed on the tensors H̅, A, B, and V, for obtaining the respective constituent tensors. Step 114-1 may comprise steps 114-1-1 to 114-1-4, in which the N×M matrix H̅ is cast to a tensor H of size 1×N×M, the N×K matrix A is cast to a tensor A of size 1×K×N, the K×K matrix V is duplicated to a tensor V of size K×K×N, and the N×M matrix B is cast to a tensor B of size K×N×1, respectively. Step 114-2 may comprise steps 114-2-1 and 114-2-2, in which the tensor for the NLOS voxel-to-AP paths B and the tensor for the diagonalised voxelated environment V are initialised prior to iteratively repeating steps 114-2-3 to 114-2-5 until the termination criterion is met. In step 114-2-3 the tensor for the NLOS UE-to-voxel paths is updated A using the previously fixed common tensors for the NLOS voxel-to-AP paths B and for the diagonalised voxelated environment V, considering the channel statistics for the NLOS UE-to-voxel paths A. In step 114-2-4 the tensor for the diagonalised voxelated environment V is updated using the previously fixed common tensor for the NLOS voxel-to-AP paths B and the updated tensor for the NLOS UE-to-voxel paths A, considering the sparsity of the diagonalised voxelated environment V. In step 114-2-5 the common tensor for the NLOS voxel-to-AP paths B using the previously fixed updated tensors for the NLOS UE-to-voxel paths A and for the diagonalised voxelated environment V, considering the channel statistics of the NLOS voxel-to-AP paths B.

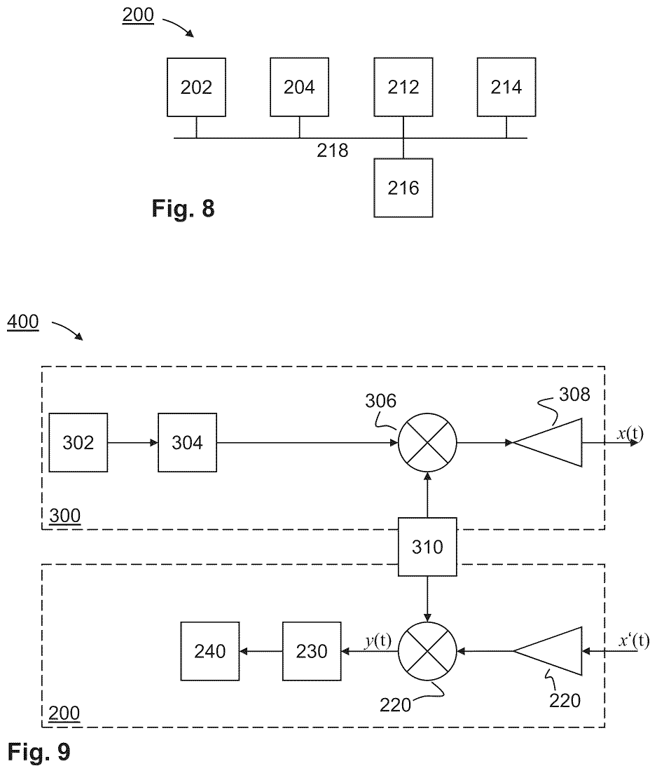

FIG. 8 shows a first exemplary block diagram of a receiver 200 in accordance with the third aspect of the invention. The receiver 200 comprises at least one antenna 202, circuitry 204 for processing radio frequency signals, a microprocessor 212, a volatile memory 214, and a non-volatile memory 216. The aforementioned elements are communicatively connected via at least one signal or data connection or bus 218. The non-volatile memory 216 stores computer program instructions which, when executed by the microprocessor 212, cause the receiver 200 to implement or execute embodiments of the method 100 according to the first aspect of the present invention as presented above.

FIG. 9 shows an exemplary and schematic diagram of a communication system 400 in accordance with an aspect of the invention. The communication system 400 comprises a receiver 200 and a transmitter 300. The transmitter 300 comprises a protocol machine 302, which may output a bit-sequence according to the protocol used in the communication system 400. Radio frequency (RF) related components 304 may perform tasks like pulse shaping the output of protocol machine 302. A first mixer 306 may mix the output of RF related component 304 with a signal from a high-frequency oscillator 310. The transmitter 300 may send, via output stage 308, a sent communication signal x(t). The output stage 308 may comprise an antenna, e.g., a rod antenna, a dipole antenna, a horn antenna, and/or a set of antennas forming a MIMO antenna.

Communication signals x′, received directly from a transmitter or reflected off an object in the region of interest prior to being received, may be received by an input stage 220 of the receiver 200. The input stage 220 may be connected to an antenna (not shown in the figure) and may comprise a low noise amplifier (not shown in the figure). A second mixer 222 may provide an intermediate frequency signal y (t) at an output. In the example of FIG. 9, the second mixer 222 uses the same oscillator 310 signal as the transmitter 300; this variation may be useful, particularly in cases when the transmitter 300 and the receiver 200 are co-located, e.g., located in the same region of a car, in the same housing, and/or in the same component, e.g., board or chip. The resulting downmixed signal y (t) may be subjected to the process in accordance with the first aspect of the invention, represented by box 230. Box 230 may comprise, use, or be implemented by various elements or components of the receiver described with reference to FIG. 8. The output of the process box 230 is provided to a signal detector 240, which ultimately outputs the transmitted signal.

LIST OF REFERENCE NUMERALS
(PART OF THE DESCRIPTION)

| | |
|---|---|
| 100 | method |
| 102 | receiving signal |
| 104 | providing pilot to CE |
| 106 | obtaining time-domain |
| | channel coefficient matrix G |
| 108 | determining channel |
| | coefficient matrix H for LOS |
| | paths |
| 110 | extracting aggregate NLOS |
| | channel coefficient matrix H̅ |
| 112 | decomposing aggregate |
| | NLOS channel matrix |
| 114 | determining A, B, and V |
| 114-1 | transform to tensors |
| 114-1-1 | cast H̅ to H̅ |
| 114-1-2 | cast A to A |
| 114-1-3 | duplicate V to V |
| 114-1-4 | cast B to B |
| 114-2 | tensor decomposition |
| 114-2-1 | initialize B |
| 114-2-2 | initialize V |
| 114-2-3 | update A |
| 114-2-4 | update B |
| 114-2-5 | update V |
| 116 | termination criterion met? |
| 118 | output results |
| 200 | receiver |
| 202 | antenna(s) |
| 204 | signal processing |
| 206 | signal transformation |
| 206-1 | signal transformation |
| 206-2 | signal transformation |
| 208 | channel estimation |
| 210 | signal detection |
| 212 | microprocessor |
| 214 | volatile memory |
| 216 | non-volatile memory |
| 218 | signal/data connection/bus |
| 220 | input stage |
| 222 | second mixer |
| 230 | processing |
| 240 | signal detector |
| 300 | transmitter |
| 302 | protocol machine |
| 304 | RF components |
| 306 | first mixer |
| 308 | output stage |
| 310 | oscillator |

1. Method of estimating NLOS sub-paths of a channel in a 3D voxelated grid map representing a wireless communication environment comprising:
receiving a transmitted signal comprising at least one pilot symbol,
providing the at least one pilot symbol to a channel estimation unit, for obtaining, at an output of the channel estimation unit, an estimation of the time-domain channel coefficient matrix representing the total effective channel,
determining an estimation of the channel coefficient matrix for LOS sub-paths of the channel,
extracting, from the channel coefficient matrix representing the total effective channel and the channel coefficient matrix representing LOS sub-paths of the channel, the aggregate NLOS channel coefficient matrix,
decomposing the aggregate NLOS channel coefficient matrix into a product of respective channel coefficient matrices for the NLOS UE-to-voxel paths and the NLOS voxel-to-AP paths, as well as the matrix representing the diagonalised voxelated environment, and
determining the channel coefficient matrices for the NLOS UE-to-voxel paths and the NLOS voxel-to-AP paths, as well as the matrix representing the diagonalised voxelated environment, through iterative estimation operations, wherein, in each iteration, sequentially each one of the matrices is estimated while the other two matrices are fixed, and wherein the iteration is terminated when a termination criterion is met.

2. The method of claim 1, wherein determining the channel coefficient matrices for the NLOS UE-to-voxel paths and the NLOS voxel-to-AP paths, as well as the matrix representing the diagonalised voxelated environment through iterative estimation operations comprises:
transforming the aggregate NLOS channel coefficient matrix into a tensor product represented by the product of tensors for the NLOS UE-to-voxel paths and the NLOS voxel-to-AP paths, respectively, as well for the diagonalised voxelated environment, and
applying a tensor decomposition method on the tensor product, for obtaining the values of the respective constituent tensors.

3. The method of claim 2, wherein transforming the aggregate NLOS channel coefficient matrix into a tensor product represented by the product of tensors for the NLOS UE-to-voxel paths and the NLOS voxel-to-AP paths, respectively, as well for the diagonalised voxelated environment, comprises:
casting the N×M matrix H̅ to a tensor H̅ of size 1×N×M,
casting the N×K matrix A to a tensor A of size 1×K×N,
duplicating the K×K matrix V to a tensor V of size K×K×N, and
casting the N×M matrix B to a tensor B of size K×N×1.

4. The method of claim 2, wherein applying a tensor decomposition method on the tensor product comprises iteratively repeating
a) updating the tensor for the NLOS UE-to-voxel paths using the previously fixed common tensors for the NLOS voxel-to-AP paths and for the diagonalised voxelated environment, considering the channel statistics for the NLOS UE-to-voxel paths,
b) updating the tensor for the diagonalised voxelated environment using the previously fixed common tensor for the NLOS voxel-to-AP paths and the updated tensor for the NLOS UE-to-voxel paths, considering the sparsity of the diagonalised voxelated environment, and
c) updating the common tensor for the NLOS voxel-to-AP paths using the previously fixed updated tensors for the NLOS UE-to-voxel paths and for the diagonalised voxelated environment, considering the channel statistics of the NLOS voxel-to-AP paths,
until a termination criterion is met.

5. The method of claim 4, further comprising:
initializing the tensor for the NLOS voxel-to-AP paths, and
initializing the tensor for the diagonalised voxelated environment prior to iteratively repeating steps a) to c).

6. A computer program product comprising computer program instructions, which, when executed by a processor of or functionally coupled with a receiver, cause the processor and/or the receiver to carry out the method of claim 1.

7. A non-transitory readable medium retrievably transmitting or storing the computer program product of claim 6.

8. A receiver for wireless communication signals comprising at least one antenna, circuitry for processing radio frequency signals, a microprocessor, volatile and non-volatile memory, connected via one or more data and/or signal lines or buses, wherein the non-volatile memory stores computer program instructions which, when executed by the microprocessor, configure components of the receiver to implement or carry out a method of claim 1.

9. The receiver of claim 8, wherein the receiver is co-located to a transmitter configured for sending communication signals.

10. The receiver claim 8, wherein the circuitry for processing radio frequency signals comprises a low noise amplifier and/or a mixer configured for providing a representation of a received signal at an intermediate frequency, using a same oscillator signal as a co-located transmitter.

11. A communication system comprising a receiver according to claim 8 and a corresponding transmitter configured for sending a communication signal.

12. (canceled)

13. The method of claim 3, wherein applying a tensor decomposition method on the tensor product comprises iteratively repeating
a) updating the tensor for the NLOS UE-to-voxel paths using the previously fixed common tensors for the NLOS voxel-to-AP paths and for the diagonalised voxelated environment, considering the channel statistics for the NLOS UE-to-voxel paths,
b) updating the tensor for the diagonalised voxelated environment using the previously fixed common tensor for the NLOS voxel-to-AP paths and the updated tensor for the NLOS UE-to-voxel paths, considering the sparsity of the diagonalised voxelated environment, and
c) updating the common tensor for the NLOS voxel-to-AP paths using the previously fixed updated tensors for the NLOS UE-to-voxel paths and for the diagonalised voxelated environment, considering the channel statistics of the NLOS voxel-to-AP paths, until a termination criterion is met.

14. The receiver of claim 9, wherein the circuitry for processing radio frequency signals comprises a low noise amplifier and/or a mixer configured for providing a representation of a received signal at an intermediate frequency, using a same oscillator signal as a co-located transmitter.
